(19) United States
(12) Patent Application Publication
(10) Pub. No.: US 2025/0210737 A1
(43) Pub. Date: Jun. 26, 2025

(54) BATTERY MANAGEMENT SYSTEM ARCHITECTURE

(71) Applicant: A123 Systems LLC, Novi, MI (US)

(72) Inventors: James Paye, West Bloomfield, MI (US); Steve Gierlach, Royal Oak, MI (US); Sandro Morero, Royal Oak, MI (US)

(21) Appl. No.: 18/990,611

(22) Filed: Dec. 20, 2024

Related U.S. Application Data
(60) Provisional application No. 63/614,447, filed on Dec. 22, 2023.

(51) Int. Cl. H01M 10/42; H02H 7/18

(52) U.S. Cl. CPC H01M 10/4257; H02H 7/18; H01M 2010/4271; H01M 2010/4278; H01M 2220/20

(57) ABSTRACT

Various systems and methods are provided for a battery management system. In one example, the battery management system includes a battery data receiving unit communicatively coupled to sensors of a battery pack. Further the battery data receiving unit includes instructions stored on non-transitory memory that when executed cause the battery data receiving unit to collect raw data from the sensors of the battery pack in a first format and transmit the collected raw data to an electronic control unit for downstream processing into a second format.

### CROSS REFERENCE TO RELATED APPLICATIONS

The present application claims priority to U.S. Provisional Application No. 63/614,447, entitled “BATTERY MANAGEMENT SYSTEM ARCHITECTURE” and filed on Dec. 22, 2023. The entire contents of the above-identified application are hereby incorporated by reference for all purposes.

### FIELD

The present description relates generally to a battery management system for a rechargeable battery.

### BACKGROUND AND SUMMARY

A battery management system (BMS) is an electronic system that may include a controller for a battery, such as a lithium-ion (Li-ion) battery. The controller may include a non-transient memory and instructions for acquiring data from battery sensors, processing said data, and triggering actuators based on the processed data. Conventionally, the manufacturer of a device or system, in which the Li-ion battery is to be installed, may acquire a BMS with pre-set instructions specific to the device or system. For example, the Li-ion battery may be used in a vehicle of a particular manufacturer. The BMS may therefore include instructions for acquiring data from battery sensors, algorithms for calculating a state of charge (SOC) and/or state of health (SOH) of the battery system based on the data, and may actuate circuits of the Li-ion battery to control a charging or discharging of the battery according to desired protocols of the specific vehicle manufacturer. The vehicle electronic control unit (ECU) may passively receive updates regarding the state of the battery system, e.g., a battery state, from the BMS.

Configuring battery control within the BMS according to specific manufacturers may result in increased costs resulting from individual programing of BMS architectures. Further, a size and weight of BMS hardware capable of performing all battery control functions as described above may be burdensome. Further, an efficiency of the Li-ion battery may be decreased based on the power draw required for operating the BMS.

The inventors herein have identified the above problems and have determined solutions to at least partially address the above problems. In one example, a BMS may comprise a battery data receiving unit communicatively coupled to sensors of a battery pack, the battery data receiving unit including instructions stored on non-transitory memory that, when executed, cause the battery data receiving unit to collect raw data from the sensors of the battery pack in a first format; and transmit the collected raw data to an electronic control unit for downstream processing into a second format. The vehicle ECU may interpret the raw data received and use the raw data in the algorithms associated with the battery pack. The data transmitted by the sensors to the battery data receiving unit may be numerical, and the resolution of the data may depend on a resolution of the sensors. The raw data may be sent to the vehicle ECU in a format understood by the ECU. The raw data may be communicated in a non-proprietary format that may be utilized by various protocols or converted to a format as desired by the primary system manufacturer. A controller of the device or system in which the Li-ion battery is installed may be a primary system which includes the algorithms for determining an overall state of the battery (e.g., SOC, SOH, etc.) and the instructions for resulting actions to be performed by the Li-ion battery, according to demands specific to the device or system. In this way, a weight and cost of the BMS may be reduced and the manufacturer of the device or system using the Li-ion battery may more easily utilize the information supplied by the BMS. In one embodiment, the device or system in which the Li-ion battery is installed may be an electric vehicle, a hybrid electric vehicle or a combustion engine vehicle, and the primary system may be a vehicle ECU.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic of an example of a secondary battery management system (BMS) in a vehicle.

FIG. 2 shows a block diagram illustrating communication between a primary ECU architecture and a secondary BMS architecture.

FIG. 3A shows a flow chart of an example of a method for a BMS having a secondary architecture.

FIG. 3B shows a flow chart of an example of a method for an ECU having a primary architecture.

### DETAILED DESCRIPTION

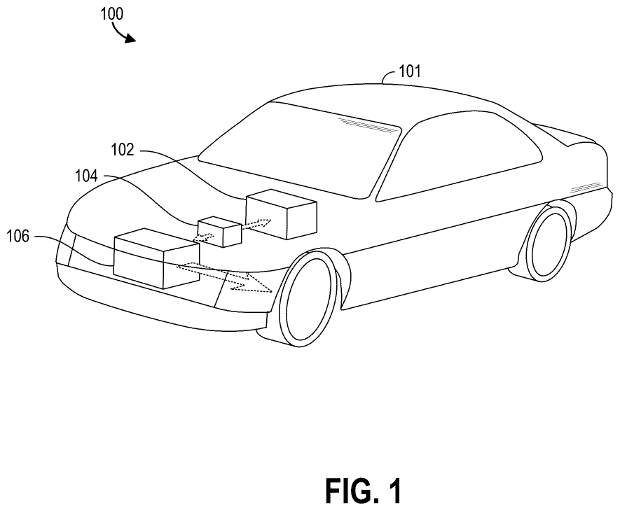

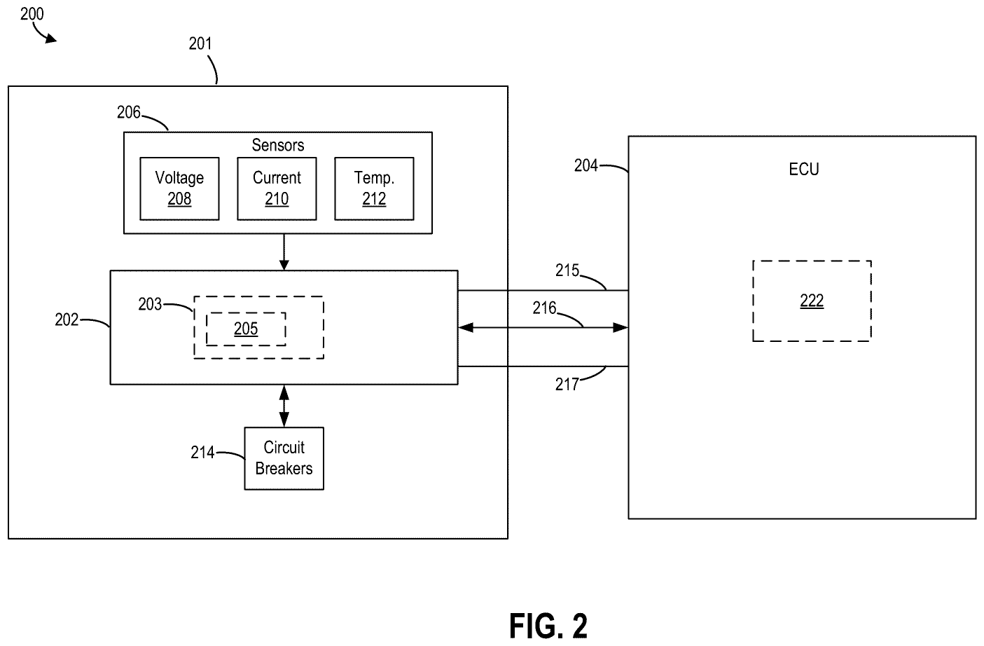

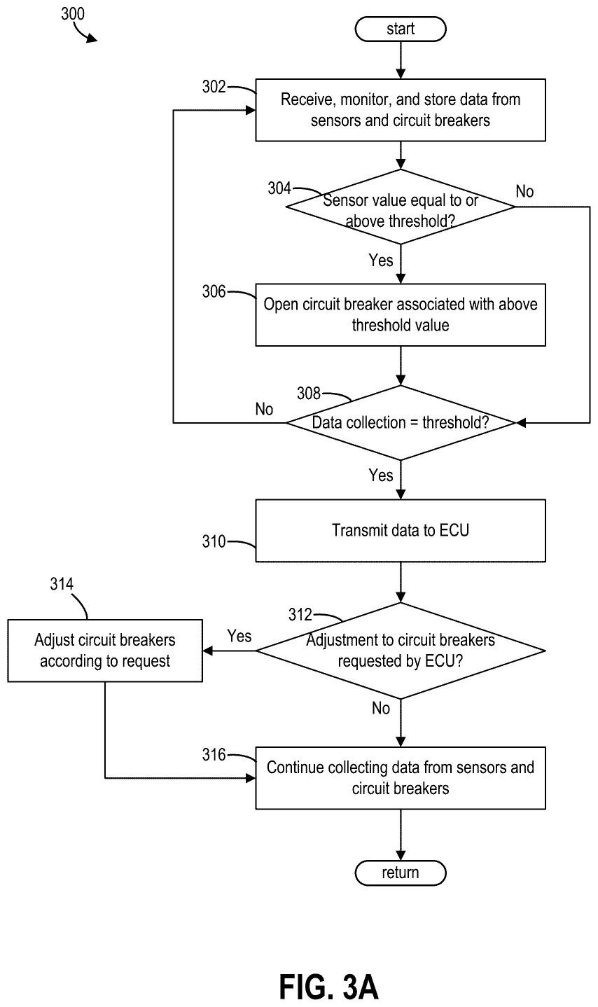

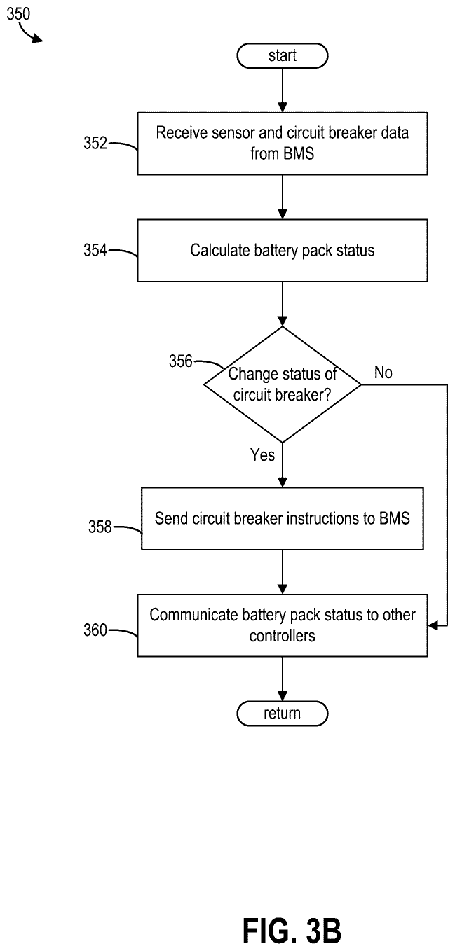

The following description relates to systems and methods for a BMS configured with a secondary architecture for a battery such as a rechargeable Li-ion battery. Herein, a secondary architecture is a set of instructions included on a battery controller which includes acquiring input data from sensors and may further include outputting sensor data, but does not include instructions for processing data or for adjusting or optimizing operation of the battery based on the processed data beyond instances of imminent battery degradation. FIG. 1 shows an embodiment of a vehicle battery system where a battery of the system may have a BMS configured with a secondary architecture. The battery may be installed in a vehicle and the vehicle ECU may be configured with a primary architecture. Herein, a primary architecture is a set of instructions included on a vehicle controller, such as the vehicle ECU, that may include receiving inputs from the battery controller and processing the inputs according to instructions specific to a platform in which the architectures are adapted for. For example, the platform may be a type of system (e.g., vehicle battery system), a specific communication format, language, and/or code, etc. The primary architecture instructions may also include sending instructions to the secondary architecture for triggering actuators. An example of a block diagram showing communication between a vehicle ECU with the primary architecture and a battery controller with the secondary BMS architecture is shown in FIG. 2. The vehicle ECU as well as sensors of the battery may each trigger opening a contactor. An example of a method for a battery controller configured with the secondary architecture of the BMS is shown in FIG. 3A and an example of a method for an ECU configured with the primary architecture is shown in FIG. 3B.

Turning now to FIG. 1, a diagram 100 of a vehicle 101 is shown including a battery pack 102 and a powertrain 106. In one example, vehicle 101 may be an electric vehicle where powertrain 106 includes an electric motor which provides the sole propulsive force to wheels of vehicle 101. In another example, vehicle 101 may be a hybrid vehicle where the wheels may be propelled by either the electric motor or an internal combustion engine (not shown). In a further example, vehicle 101 may be a configured to be propelled by the internal combustion energy without the electric motor. Battery pack 102 may include a microcontroller or a customized application-specific integrated circuit (ASIC) configured with a BMS for monitoring parameters of battery pack 102, e.g., battery parameters. The BMS may be communicatively coupled to the vehicle ECU 104. In one example, the BMS of battery pack 102 may be configured with a secondary architecture to output sensor data to the vehicle ECU 104 in a data format that is usable by a variety of platforms. The data format may be a multi-platform format.

Conventionally, a BMS of a rechargeable battery pack may be configured as a primary architecture that is programmed by a battery manufacturer to receive inputs from battery sensors, process the inputs which may include calculating battery system attributes such as SOC or SOH from the sensor inputs, and actuate components of the battery according to algorithms pre-set by the battery manufacturer. However, the BMS may not be readily customized to use across different platforms. Configuring each BMS provided by the battery manufacturer with algorithms specific to a platform may be costly and demanding with respect to production efficiency and output. A decreased weight and cost of the battery pack, as well as broadened compatibility, may be achieved by configuring the BMS with simplified, secondary architecture. The platform in which the battery is installed, such as a vehicle, may include a controller configured with a primary architecture that receives raw data, e.g., unprocessed data in a non-proprietary format, from the secondary architecture in a format that is recognized by the primary architecture. Additionally, a manufacturer providing the controller with the primary architecture may be able to increase a performance of the battery pack as a result of access to the raw data supplied by the secondary architecture of the BMS. An example of communication and data flow between a secondary BMS architecture and a primary vehicle ECU architecture is further discussed below with respect to FIG. 2.

FIG. 2 shows a block diagram 200 of a rechargeable battery pack 201 and an ECU 204. In one example ECU 204 may be an ECU of vehicle such as vehicle 101 of FIG. 1. In another example, rechargeable battery pack 201 may include one or more rechargeable battery cells such as Li-ion battery cells (not shown). Battery pack 201 may be monitored and controlled by a BMS 203 installed on a battery data receiving unit, where the battery data receiving unit may be a simple low-power battery controller 202. In one example, controller 202 may be a microcontroller. In another example, controller 202 may be an ASIC specific, e.g., customized, to the BMS 203. BMS 203 may have a secondary architecture 205 which may include instructions related to input of data sensors 206 and output of sensor information to ECU 204. Further, BMS 203 may receive instructions input from ECU 204 for actuating battery components such as one or more circuit breakers 214. The one or more circuit breakers 214 may be configured to reversibly electrically couple one or more battery cells of rechargeable battery pack 201 from the remainder of the battery cells and/or from the electrical load or charger coupled to the rechargeable battery pack 201. The one or more circuit breakers 214 may control flow of electricity to and from the battery cells and to and from the battery cells and components external to the battery pack.

Raw data collected from sensors 206 may be input to BMS 203 via a first mode, such as parallel connection to an analog to digital converter of controller 202 of BMS 203. The raw data may be transmitted to BMS 203 in a first format, such as voltage level connected to an analog to digital converter of the BMS. Sensors 206 may be sensors coupled to the one or more battery cells of rechargeable battery pack 201. Sensors 206 may include one or more voltage sensors 208 for monitoring and reporting a voltage at each of the one or more battery cells. Sensors 206 may also include one or more current sensors 210 monitoring and reporting a charging and/or discharging current at each of the battery cells. Sensors 206 may also include one or more temperature sensors 212 for monitoring and reporting a temperature of each of the battery cells. A status of the one or more circuit breakers 214 (e.g., open or closed) may also be communicated to BMS 203.

The secondary architecture 205 of BMS 203 may include instructions for outputting the data of sensors 206 to ECU 204 via a second mode, which may be a communication protocol 216. The BMS 203 does not process the raw data from the sensors 206. The BMS may transmit the raw data to ECU 204 in the first format for downstream processing at ECU 204. In one example, the raw data is encoded according to a mode of data flow between the sensors 206 and the BMS 203, e.g., the first format, that depends on how the data is received by the BMS 203. For example, the controller 202 may include a first wire 215, which may be a transmission wire, and a second wire 217, which may be a reception wire. The reception wire may receive the sensor data and encode the data in a format that may be used across many various platforms. The encoded data may be transmitted to ECU 204 via the transmission wire in the same format as received. Alternatively, the controller 202 may receive the sensor data in one format, according to a data format of the sensors and transmit the data in another format according to the transmission wire type. Encoding data into different formats may make the data readable by the ECU. Encoding data is not equivalent to processing data which transforms the raw data into metrics of the battery system such as SOC and SOH. The BMS may encode the raw data but may not further process the raw data. In some examples, the first mode of data flow and the second mode of data flow may use the same low cost communication protocol.

As one example, communication protocol 216 may rely on the transmission wire and may be a simple low cost communication protocol such as Peripheral Sensor Interface 5 (PSI5) protocol. For example, when communication protocol 216 uses PSI5, it may communicate at a maximum rate of 189 kilobytes per second (kbps). Additionally, PSI5 may use Manchester encoded (e.g., phase encoded) data transmission.

ECU 204 may be configured with primary architecture 222 for processing the raw data received from controller 202 and outputting the data in a second format that is different from the first format. ECU 204 may output values related to a status of the battery such as SOC, SOH, and/or a battery power limit. Primary architecture 222 may include data-processing algorithms implemented by the ECU which are specialized for the system or device in which the ECU is installed. Primary architecture 222 may further include instructions for outputting commands to BMS 203 via communication protocol 216 to adjust one or more circuit breakers 214 between open and closed based on the status of the battery. Additionally, ECU 204 may control other actuators of the system in response to values output by the algorithms of primary architecture 222. For example, in an embodiment where ECU 204 is the ECU of a hybrid vehicle, ECU 204 may prioritize regenerative braking in response to an SOC of the battery pack 201 falling below a threshold SOC, as calculated by primary architecture 222.

Secondary architecture 205 may be configured to receive instructions from ECU 204 regarding actuating on or more of circuit breakers 214 open. Additionally, secondary architecture 205 of BMS 203 may also include instructions to actuate one or more of circuit breakers 214 open, e.g., electrically disconnecting one or more battery cells of the battery pack 201, if values input by sensors 206 are above a threshold value. Threshold values may be set at values above which a battery cell may degrade the remaining cells of the battery pack and/or the electrical system of the vehicle. In this way, secondary architecture 205 provides a back-up system for opening one or more circuit breakers 214 in circumstances where the battery pack 201 and the system in which it is installed may be degraded. Further details regarding methods executed by the secondary BMS and the primary ECU are discussed below with respect to FIGS. 3A-3B.

FIGS. 3A-3B show flowcharts of methods 300 and 350 for a managing a battery system of a vehicle at a battery data receiving unit (such as a microcontroller or ASIC) of a battery pack and at an ECU of the vehicle, respectively. The battery data receiving unit may be equipped with a BMS having a secondary architecture and the ECU configured with a primary architecture. Instructions for carrying out the methods 300, 350 may be executed by the battery data receiving unit and the ECU, respectively, based on the instructions stored in a non-volatile memory of the respective controller. Furthermore, executions of the methods 300 and 350 may occur concurrently. The vehicle (e.g., vehicle 101 of FIG. 1) may be a hybrid vehicle, an electric vehicle or a combustion engine vehicle. The battery data receiving unit may monitor a status of a rechargeable Li-ion battery, as described above with respect to FIG. 2.

Turning now to FIG. 3A, at 302, the method 300, as executed based on the secondary architecture of the BMS, includes receiving, monitoring, and storing data from the sensors of a battery pack to which the secondary BMS is coupled. Receiving, monitoring, and storing data may together comprise collecting raw data from the sensors and circuit breakers. The sensors may be coupled to each cell of a plurality of battery cells of the battery pack and may include voltage, current and/or temperature sensors as described above with respect to FIG. 2. In addition to sensor data, the BMS receives information from the circuit breakers of the plurality of battery cells regarding their statuses (e.g., open or closed). Receiving may include obtaining the raw data sent to the BMS by the sensors. Monitoring may include continually comparing the received values to threshold values as described further below. Storing may include saving packets of the received data in a memory of the BMS. For example, the sensor data may be stored in a temporary memory of the BMS before transmitting the data packet to the ECU as described further below.

At 304, the method 300 includes determining if data values received from the sensors are equal to or above respective thresholds. Respective thresholds may be one or more battery parameter thresholds and may include thresholds for each battery parameter sensed by the sensors. Respective thresholds may also be referred to as one or more operating threshold values of the battery pack. Respective thresholds may include one or more of a voltage threshold, a current threshold, and a temperature threshold. The respective thresholds may be maximum values of the one or more battery parameters, above which battery degradation may be expected. As described above, a sensor value above a threshold may indicate an increased likelihood of battery degradation or imminent degradation of a battery cell.

If a sensor value reaches and/or exceeds the respective threshold value (e.g., is equal to or above) a threshold, the method 300 proceeds to 306 to command opening of the circuit breaker of the battery cell associated with the above-threshold sensor value. Reaching the respective threshold value may occur if at least one threshold value of the respective threshold values is reached. Opening of the circuit breaker may include opening at least one circuit breaker of the one or more circuit breakers of the rechargeable battery pack. Opening the circuit breaker may electrically decouple the battery cell associated with the above-threshold sensor value from the remaining battery cells of the rechargeable battery pack and/or from the device electrically coupled to the rechargeable battery pack. If there are no sensors values above the threshold, then the method 300 proceeds to 308 to compare if a threshold of data collection is met.

At 308, the method 300 includes determining if data collection reaches the threshold. For example, the battery data receiving unit may be configured with preset data transmission rules. The preset data transmission rules may be pre-set rules defining the data collection threshold. As one example, the data collection threshold may be a threshold amount of data. The threshold amount of data may be a minimum amount of data to be communicated as a packet to the ECU at 310, such as an amount of data that can be sent in 1 second by a PSI5 protocol (e.g., 189 kilobytes). As another example, the data collection threshold may be a preset threshold duration of time for data collection. For example, the preset duration of time may be 0.5 second, 1 second, 5 seconds, etc. If the data collection threshold is not met, the method 300 returns to 302 to continue receiving, monitoring, and storing data from the sensors and the circuit breakers until the data collection threshold is reached. If the data collection does meet the threshold, the data is transmitted to the ECU at 310. The transmitted data may be the raw data of the sensors. The data may be transmitted to the ECU via low-cost protocol, as described above with respect to FIG. 2. The input data may be processed by the ECU as described further below with respect to the method 350 in FIG. 3B below.

At 312, the method 300 includes determining if adjusting circuit breakers is requested by the ECU. Adjusting circuit breakers may include opening or closing one or more circuit breakers. For example, the ECU may communicate instructions to the BMS of the battery data receiving unit via the same communication protocol used to transmit data to the ECU at 310. The instructions may be determined by the primary architecture of the ECU following the method 350 described below with respect to FIG. 3B.

If, at 312, adjustment of circuit breakers is requested, the method 300 proceeds to 314 and the circuit breakers may be adjusted according to the request received at 312. Adjusting the circuit breakers may include actuating one or more of the circuit breakers from an open state to a closed state or from a closed state to an open state. Actuating may include the BMS commanding opening or closing of one or more of the circuit breakers. In one example, actuating may include opening at least one circuit breaker of the one or more circuit breakers. If, at 312, no adjustment of the circuit breakers is requested, the method 300 continues to 316 to continue collecting data from the sensors and the circuit breakers. Collecting data from the sensors may include monitoring, receiving, and storing data as described above with respect to step 302. The method 300 returns to the start.

Turning now to FIG. 3B, at 352, the method 350 includes receiving the sensor data and circuit breaker data (e.g., circuit breaker status) from the battery data receiving unit of FIG. 2. The data received by the ECU corresponds to the data sent by the BMS of the battery data receiving unit at 310 of the method 300.

At 354, the method 350, as executed by the ECU based on the primary architecture of the ECU, includes calculating a status or condition of the battery pack. Calculating the status of the battery pack may include estimating metrics such as battery SOC and SOH which are calculated using the data from the sensors communicated to the ECU from the BMS. The ECU may calculate the status of the battery pack using data processing algorithms stored on a non-transitory memory of the ECU. The data processing algorithms may not be stored in non-transitory memory of the BMS.

At 356, the method 350 includes determining if changes to status of one or more of the circuit breakers is demanded. The primary architecture of the ECU may include algorithms which assess battery pack health based on the estimated metrics, e.g., as SOC and SOH. The battery pack health may be used to determine whether or not opening of one or more circuit breakers (e.g., circuit breakers that are currently closed) of the battery pack is demanded. If it is determined that the status of a circuit breaker is to be changed (e.g., from open to closed or closed to open), then, at 358, the method 350 includes sending circuit breaker instructions to the BMS. Sending circuit breaker instructions may include sending a command to the battery data receiving unit to adjust the corresponding circuit breakers to an opened or closed state. If, at 356, it is determined that changes to the statuses of the circuit breakers is not demanded, the method 350 proceeds to 360 to update a status of the battery pack at another vehicle controller, such as a powertrain control module (PCM).

For example, at 360, the status of the battery pack, based on the status/condition determined at 354 and instructions to change or not change the circuit breaker statuses as determined at 356 may comprise an overall evaluation of the battery pack status/condition may be communicated to, for example, the PCM. The PCM may adjust power consumption from the battery pack based on the status of the battery pack. For example, the vehicle may be a hybrid vehicle and the battery pack status information may be used by the PCM to adjust vehicle propulsion by battery versus engine power to optimize battery pack usage according to its condition. The method 350 returns to the start.

In this way, a BMS may be provided with a battery pack where the BMS has a reduced complexity relative to conventional BMSs, and with a broadened compatibility across different platforms. The battery pack may therefore be used by a variety of systems and devices at low cost, resulting from simplified and faster manufacturing of the BMS hardware with the battery pack. In some examples, a manufacturer or supplier of the battery pack may develop algorithms that are conventionally included in the BMS. The algorithms may instead be available by license to a customer and may be AUTOSAR compliant, for example, such that the licensed algorithms may be readily imported into an ECU.

The technical effect of implementing a BMS with a secondary architecture to monitor operating parameters of a battery pack is a reduced size and cost of a battery pack. The BMS may only be responsible for communicating data of the battery sensors to an ECU and, in an event of an over-threshold sensor value, opening one or more circuit breakers of the battery pack. The ECU configured with a primary architecture may perform logic-heavy and computing-intensive tasks of calculating battery status and determining if a circuit breaker of a battery cell demands to be opened or closed to control battery pack operating conditions. Moving computing tasks from the BMS to the ECU allows for a smaller, less expensive controller to be used for the BMS. Additionally, the BMS with secondary architecture may be used with many different platforms thus minimizing the programming hours for an individual BMS.

The disclosure also provides support for a battery management system, comprising: a battery data receiving unit communicatively coupled to sensors of a battery pack, the battery data receiving unit including instructions stored on non-transitory memory that, when executed, cause the battery data receiving unit to: collect raw data from the sensors of the battery pack in a first format, and transmit the collected raw data in the first format to an electronic control unit for downstream processing into a second format. In a first example of the system, the sensors include one or more of a voltage sensor, a current sensor, and a temperature sensor, and wherein the first format is a non-proprietary format. In a second example of the system, optionally including the first example, the battery data receiving unit is communicatively coupled to one or more circuit breakers of the battery pack, and wherein the battery data receiving unit further includes instruction that, when executed, cause the battery data receiving unit to: open at least one circuit breaker of the one or more circuit breakers when the collected raw data reaches at least one threshold value indicating imminent degradation of the battery pack. In a third example of the system, optionally including one or both of the first and second examples, the battery data receiving unit is communicatively coupled to the electronic control unit by Peripheral Sensor Interface 5 protocol. In a fourth example of the system, optionally including one or more or each of the first through third examples, the battery data receiving unit is communicatively coupled to the electronic control unit by a first wire and to the sensors by a second wire. In a fifth example of the system, optionally including one or more or each of the first through fourth examples, the first wire and the second wire are configured for Manchester encoded data transmission. In a sixth example of the system, optionally including one or more or each of the first through fifth examples, the battery data receiving unit is one of a microcontroller or a customized application-specific integrated circuit (ASIC). In a seventh example of the system, optionally including one or more or each of the first through sixth examples, the second format is different from the first format, and wherein the downstream processing at the electronic control unit includes estimating one or more of a battery state of charge, a battery state of health, a battery power limit based on data processing algorithms implemented at the electronic control unit and not at the battery data receiving unit.

The disclosure also provides support for a method for a battery management system, comprising: receiving raw data at a battery data receiving unit from battery sensors coupled to a battery pack, storing the raw data until data collection at the battery data receiving unit reaches a data collection threshold, and responsive to the data collection reaching the data collection threshold, transmitting the raw data from the battery data receiving unit to an electronic control unit for downstream processing to determine a condition of the battery pack. In a first example of the method, the method further comprises: monitoring the raw data and comparing the raw data to one or more battery parameter thresholds, and wherein the one or more battery parameter thresholds indicates a maximum value of a battery parameter above which the battery pack becomes degraded. In a second example of the method, optionally including the first example, the method further comprises: , responsive to the raw data reaching one of the one or more battery parameter thresholds, commanding opening of one or more circuit breakers of the battery pack. In a third example of the method, optionally including one or both of the first and second examples, the method further comprises: , responsive to a request received from the electronic control unit subsequent to downstream processing of the raw data, commanding opening of one or more circuit breakers of the battery pack. In a fourth example of the method, optionally including one or more or each of the first through third examples, storing the raw data until data collection reaches the data collection threshold includes storing the raw data until one of a threshold amount of data or a threshold duration of data collection is met. In a fifth example of the method, optionally including one or more or each of the first through fourth examples, receiving the raw data includes receiving the raw data in a format according to a first mode of data flow between the battery sensors and the battery management system without processing the raw data, and wherein transmitting the raw data includes transmitting the raw data according to a second mode of data flow between the battery management system and the electronic control unit. In a sixth example of the method, optionally including one or more or each of the first through fifth examples, the first mode of data flow and the second mode of data flow are a same low cost communication protocol.

The disclosure also provides support for a battery pack for a vehicle, comprising: sensors coupled to cells of the battery pack, the sensors monitoring one or more of a voltage, a current, and a temperature of the cells of the battery pack, circuit breakers electrically coupled to the cells to control flow of electricity from the cells to components external to the battery pack, and a battery data receiving unit communicatively coupled to each of the sensors, the circuit breakers, and an electronic control unit of the vehicle, the battery data receiving unit configured with a battery management system to transmit raw data from the sensors to the electronic control unit in a multi-platform format for downstream processing of the raw data. In a first example of the system, the battery management system is configured to monitor the raw data from the sensors and command at least one of the circuit breakers to open when the raw data from the sensors exceeds one or more operating threshold values, and wherein the one or more operating threshold values are values above which a likelihood of degradation to the battery pack is increased. In a second example of the system, optionally including the first example, the battery data receiving unit is one of a microcontroller or an application-specific integrated circuit configured with instructions to transmit the raw data to the electronic control unit according to preset data transmission rules. In a third example of the system, optionally including one or both of the first and second examples, the battery management system is implemented at the battery data receiving unit without algorithms for processing the raw data from the sensors. In a fourth example of the system, optionally including one or more or each of the first through third examples, the electronic control unit has a primary architecture and the battery management system has a secondary architecture, and wherein the primary architecture is a set of instructions for receiving inputs from the secondary architecture and processing the inputs according to a platform of the vehicle and the secondary architecture is a set of instructions for acquiring the raw data from sensors and outputting the raw data from the sensors.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A battery management system, comprising:
a battery data receiving unit communicatively coupled to sensors of a battery pack, the battery data receiving unit including instructions stored on non-transitory memory that, when executed, cause the battery data receiving unit to:
collect raw data from the sensors of the battery pack in a first format; and
transmit the collected raw data in the first format to an electronic control unit for downstream processing into a second format.

2. The battery management system of claim 1, wherein the sensors include one or more of a voltage sensor, a current sensor, and a temperature sensor, and wherein the first format is a non-proprietary format.

3. The battery management system of claim 1, wherein the battery data receiving unit is communicatively coupled to one or more circuit breakers of the battery pack, and wherein the battery data receiving unit further includes instruction that, when executed, cause the battery data receiving unit to:
open at least one circuit breaker of the one or more circuit breakers when the collected raw data reaches at least one threshold value indicating imminent degradation of the battery pack.

4. The battery management system of claim 1, wherein the battery data receiving unit is communicatively coupled to the electronic control unit by Peripheral Sensor Interface 5 protocol.

5. The battery management system of claim 1, wherein the battery data receiving unit is communicatively coupled to the electronic control unit by a first wire and to the sensors by a second wire.

6. The battery management system of claim 5, wherein the first wire and the second wire are configured for Manchester encoded data transmission.

7. The battery management system of claim 1, wherein the battery data receiving unit is one of a microcontroller or a customized application-specific integrated circuit (ASIC).

8. The battery management system of claim 1, wherein the second format is different from the first format, and wherein the downstream processing at the electronic control unit includes estimating one or more of a battery state of charge, a battery state of health, a battery power limit based on data processing algorithms implemented at the electronic control unit and not at the battery data receiving unit.

9. A method for a battery management system, comprising:
receiving raw data at a battery data receiving unit from battery sensors coupled to a battery pack;
storing the raw data until data collection at the battery data receiving unit reaches a data collection threshold; and
responsive to the data collection reaching the data collection threshold,
transmitting the raw data from the battery data receiving unit to an electronic control unit for downstream processing to determine a condition of the battery pack.

10. The method of claim 9, further comprising monitoring the raw data and comparing the raw data to one or more battery parameter thresholds, and wherein the one or more battery parameter thresholds indicates a maximum value of a battery parameter above which the battery pack becomes degraded.

11. The method of claim 10, further comprising, responsive to the raw data reaching one of the one or more battery parameter thresholds, commanding opening of one or more circuit breakers of the battery pack.

12. The method of claim 9, further comprising, responsive to a request received from the electronic control unit subsequent to downstream processing of the raw data, commanding opening of one or more circuit breakers of the battery pack.

13. The method of claim 9, wherein storing the raw data until data collection reaches the data collection threshold includes storing the raw data until one of a threshold amount of data or a threshold duration of data collection is met.

14. The method of claim 9, wherein receiving the raw data includes receiving the raw data in a format according to a first mode of data flow between the battery sensors and the battery management system without processing the raw data, and wherein transmitting the raw data includes transmitting the raw data according to a second mode of data flow between the battery management system and the electronic control unit.

15. The method of claim 14, wherein the first mode of data flow and the second mode of data flow are a same low cost communication protocol.

16. A battery pack for a vehicle, comprising:
sensors coupled to cells of the battery pack, the sensors monitoring one or more of a voltage, a current, and a temperature of the cells of the battery pack;
circuit breakers electrically coupled to the cells to control flow of electricity from the cells to components external to the battery pack; and
a battery data receiving unit communicatively coupled to each of the sensors, the circuit breakers, and an electronic control unit of the vehicle, the battery data receiving unit configured with a battery management system to transmit raw data from the sensors to the electronic control unit in a multi-platform format for downstream processing of the raw data.

17. The battery pack of claim 16, wherein the battery management system is configured to monitor the raw data from the sensors and command at least one of the circuit breakers to open when the raw data from the sensors exceeds one or more operating threshold values, and wherein the one or more operating threshold values are values above which a likelihood of degradation to the battery pack is increased.

18. The battery pack of claim 16, wherein the battery data receiving unit is one of a microcontroller or an application-specific integrated circuit configured with instructions to transmit the raw data to the electronic control unit according to preset data transmission rules.

19. The battery pack of claim 16, wherein the battery management system is implemented at the battery data receiving unit without algorithms for processing the raw data from the sensors.

20. The battery pack of claim 16, wherein the electronic control unit has a primary architecture and the battery management system has a secondary architecture, and wherein the primary architecture is a set of instructions for receiving inputs from the secondary architecture and processing the inputs according to a platform of the vehicle and the secondary architecture is a set of instructions for acquiring the raw data from sensors and outputting the raw data from the sensors.
